(19) United States
(12) Patent Application Publication
(10) Pub. No.: US 2026/0338192 A1
(43) Pub. Date: Oct. 29, 2026

(54) Variable Speed Air Blower

(71) Applicant: AquaStar Pool Products, Inc., Ventura, CA (US)

(72) Inventor: Olaf Mjelde, Ventura, CA (US)

(73) Assignee: AquaStar Pool Products, Inc., Ventura, CA (US)

(21) Appl. No.: 19/360,933

(22) Filed: Oct. 16, 2025

Related U.S. Application Data
(60) Provisional application No. 63/793,447, filed on Apr. 23, 2025.

(51) Int. Cl. F04D 25/08; A61H 33/02; F04D 1/04; F04D 27/00; F04D 29/62

(52) U.S. Cl. CPC F04D 25/08; A61H 33/028; F04D 1/04; F04D 27/004; F04D 29/62

(57) ABSTRACT

A variable speed air blower assembly for use with spas, pools and water features is provided. The variable speed air blower assembly includes an upper and a lower housing enclosing a motor and fan assembly, where the motor and fan are isolated from the upper and lower housings by means of a vibration dampener to reduce vibration and noise. The design isolates inlet from outlet airflow to improve blower motor cooling capacity. Blower motor speed is controlled by an electrical circuit which chops an AC wave form using a triac based design.

### CROSS-REFERENCE TO RELATED APPLICATION

This patent application claims priority to U.S. Application No. 63/793,447, filed Apr. 23, 2025, and is incorporated in its entirety herewith by this reference.

### BACKGROUND OF THE INVENTION

### Field of the Invention

The present invention relates to air blower assemblies, and has particular reference to air blower assemblies for use on spas, pools and water features where introducing air bubbles into a water stream is desirable.

### Background of the Invention

Air blower assemblies have long been used in spas, pools and water features and are popular accessories for enhancing the enjoyment of such products. Typically, the assembly is enclosed with the water heating and circulation equipment, and has selectively operable controls for activating the assembly to force air into a water jet which discharges into the spa, pool or water feature.

One disadvantage of prior art blower assemblies has been the lack of a variable speed control, which would allow a user to vary the air flow in a water jet. With prior art designs, users must either purchase a blower with a precise power rating to achieve the desired airflow, or oversize the blower and vent excess air to the atmosphere. Such air venting leads to increased power consumption which increases operator costs and the use of an oversized blower can cause the blower motor to overheat due to lack of adequate cooling air.

Another disadvantage of prior art blower assemblies has been a lack of a modern communication protocol and micro-processer based control which would allow for more accurate temperature, motor load control and monitoring, as well as integration with automated control systems.

Another disadvantage of prior art blower assemblies has been the lack of an air flow path through the blower assembly housing that is optimized to cool the blower motor.

Yet another disadvantage of prior art blower assemblies has been the noise they generate. The assemblies include blower and motor units that operate at high speed to produce the necessary air flow to a spa or pool water jet, and the combination of motor and fan noise typically produces a relatively high-pitched whine that detracts from the atmosphere of the spa or pool. Efforts have been made to reduce this noise by enclosing the assembly in sound barrier insulation. While such efforts have offered some noise reduction, there remains substantial room in the art for further improvements.

What is needed in the art therefore is a blower assembly that offers variable speed control, a modern communications protocol, improved air cooling and improved noise reduction.

### SUMMARY OF THE INVENTION

The present invention is directed to a variable speed air blower assembly where the variable speed control allows for air flow adjustability to spa and pool water jets. The new variable speed air blower uses a brushed AC motor coupled to a blower fan with flow-through air cooling. The motor speed is controlled by a speed control unit having a control circuit that chops the AC wave form using a triac based circuit, which may be microprocessor controlled. Using a microprocessor to control the dimmer circuit provides improved ability to monitor blower motor temperature and reduce motor speed if the temperature exceeds a preset threshold, thus preventing the motor from overheating. Microprocessor control further provides the ability to communicate with external automation systems via an RS485 communications standard for motor on/off and speed controls. Monitoring system health and reporting back error codes is also possible as is turning the blower motor on and off utilizing a low voltage, dry contact signal. A single gang junction box is provided on the exterior of the blower assembly housing that allows customers to wire power through standard toggle switches or smart IoT switches.

The variable speed air blower of the present invention comprises upper and lower blower housings made from a sound absorbing material, such as various plastic materials. The blower motor and fan are an integrated unit and are suspended within the lower blower housing from a vibration dampener, which reduces fan noise by isolating the blower motor and fan from the upper and lower blower housings. An air cone interfaces with the vibration dampener and surrounds the blower motor and the fan air outlet. The air cone isolates inlet air flow from outlet air flow. The separate air inlet and outlet flow paths serve to improve blower motor cooling.

The upper blower housing interfaces with the vibration dampener and provides an upper air chamber above the fan. A blower assembly speed control unit and heatsink attach to a top portion of the upper blower housing and are disposed within the upper air chamber. A shaft, such as a potentiometer shaft, for blower motor speed adjustment extends from the control board through an opening in the upper blower housing to provide for manual control of blower motor speed.

The variable speed air blower of the present invention improves blower motor cooling by drawing in inlet air from about the perimeter of the base of the lower blower housing and into an upper air chamber above the fan. Compressed air from the fan is subsequently blown around the perimeter of the blower motor and is exhausted threw an outlet located in the center of the base of the blower motor housing. Inlet air flow is isolated from outlet air flow by means of the air cone in the lower blower housing, which improves motor cooling.

The upper and lower blower housings include indentations spaced about the perimeter of the housings. The indentations function to increase the surface area of the housings and thereby improve cooling of the blower assembly. The indentations also increase the rigidity of the upper and lower blower housings.

The above and other features and advantages of the present invention will become apparent from the following detailed description, taken in conjunction with the accompanying drawings.

### BRIEF DESCRIPTION OF THE DRAWINGS

FIG. 1 is side view the variable speed air blower assembly of the present invention;

FIG. 2 is a top view of the variable speed air blower assembly of FIG. 1;

FIG. 3 is a cross-sectional view taken along the line A-A of FIG. 1;

FIG. 4 is an exploded view of the variable speed air blower assembly of FIG. 1;

FIG. 5 is a bottom view of the variable speed air blower assembly of FIG. 1;

FIG. 6 is a cross-sectional view taken along the line B-B of FIG. 3;

FIG. 7 is a schematic circuit diagram of a control circuit of the variable speed air blower assembly of the present invention.

### DETAILED DESCRIPTION OF THE PREFERRED EMBODIMENTS

The present invention will now be described more fully hereinafter with reference to the accompanying drawings, in which preferred embodiments of the invention are shown. The invention may, however, may be embodied in many different forms and should not be construed as being limited to the embodiments set forth herein. Rather these embodiments are provided so that this disclosure will be thorough and complete, and will fully convey the scope of the invention to those skilled in the art. Like numbers refer to like elements throughout.

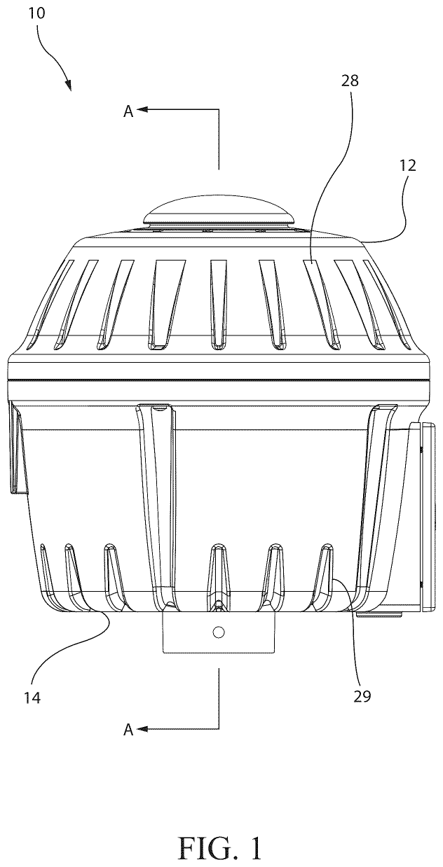

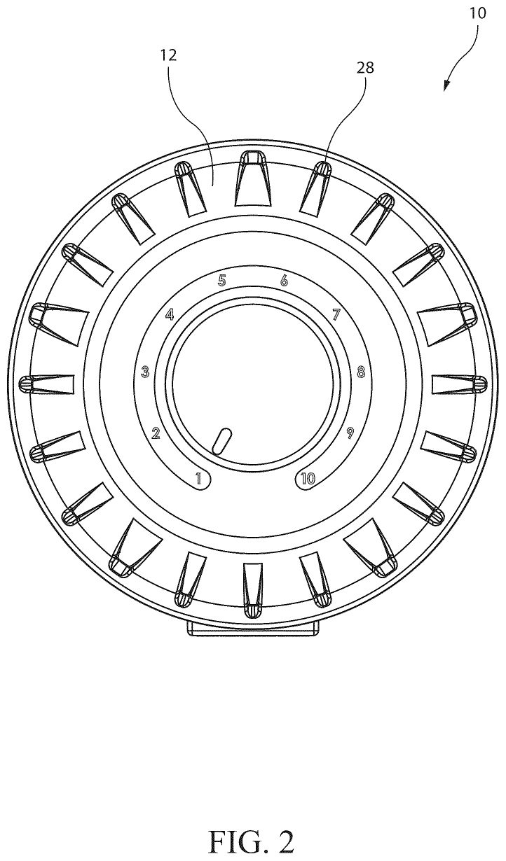

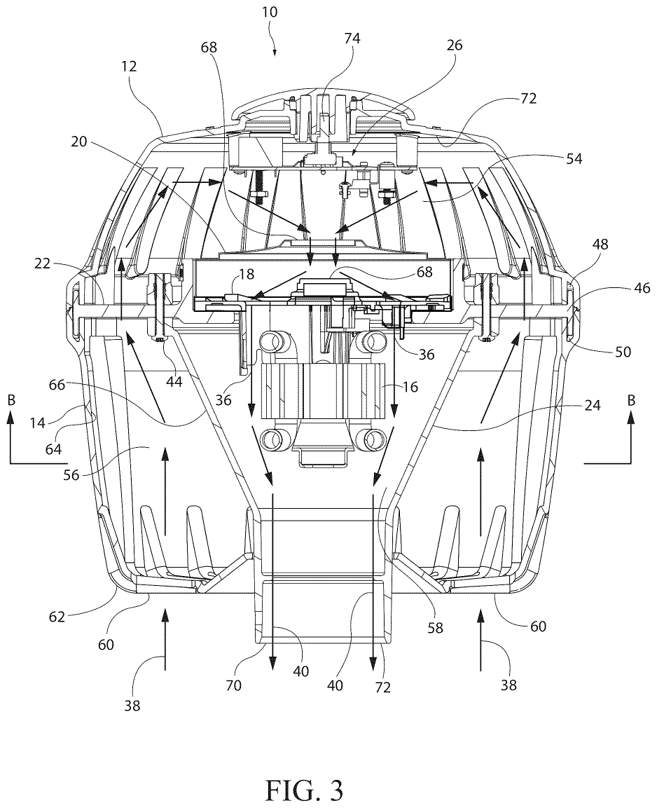

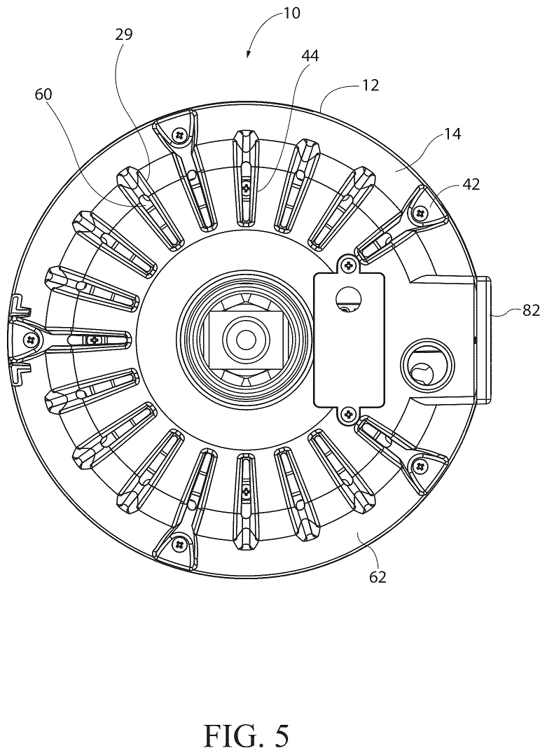

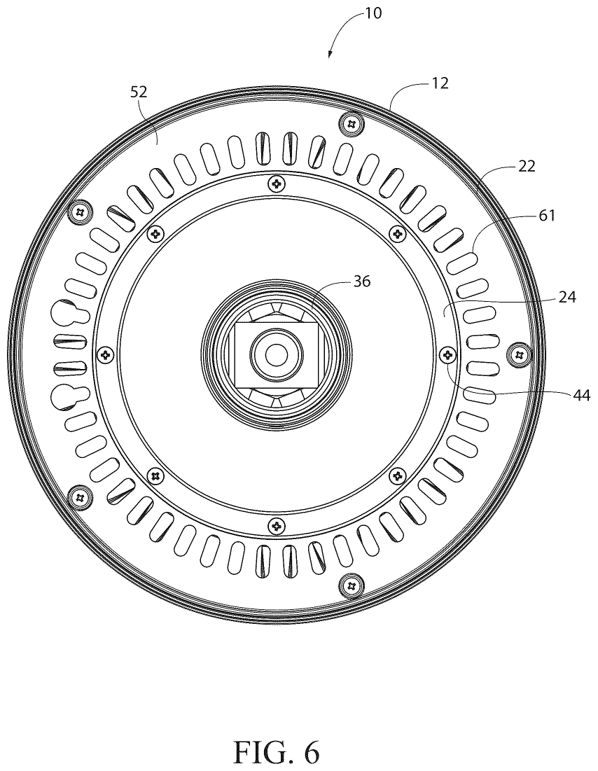

With reference to FIGS. 1-6 and with particular reference to FIG. 3, the variable speed air blower 10 of the present invention includes an upper housing 12, a lower housing 14, a blower motor 16 and a fan 18 enclosed within a fan housing 20, a vibration dampener 22, an air outlet cone or hollow cone 24 and a blower motor speed control unit 26.

The upper housing 12 and the lower housing 14 are formed from glass reinforced plastic (“GRP”) materials or other sound absorbing materials. The upper housing 12 includes a plurality of indentations 28 spaced about the perimeter of the housing. The plurality of indentations 28 function to increase the surface area of the upper housing and thereby improve cooling of the blower motor 16. The lower housing 14 includes a plurality of indentations 29 which include a plurality of air inlets 60, spaced about the perimeter of the lower housing. The indentations 28 and 39, also increase the rigidity of the upper and lower housings 12 and 14, respectively, as well as provide for a more pleasing aesthetic appearance.

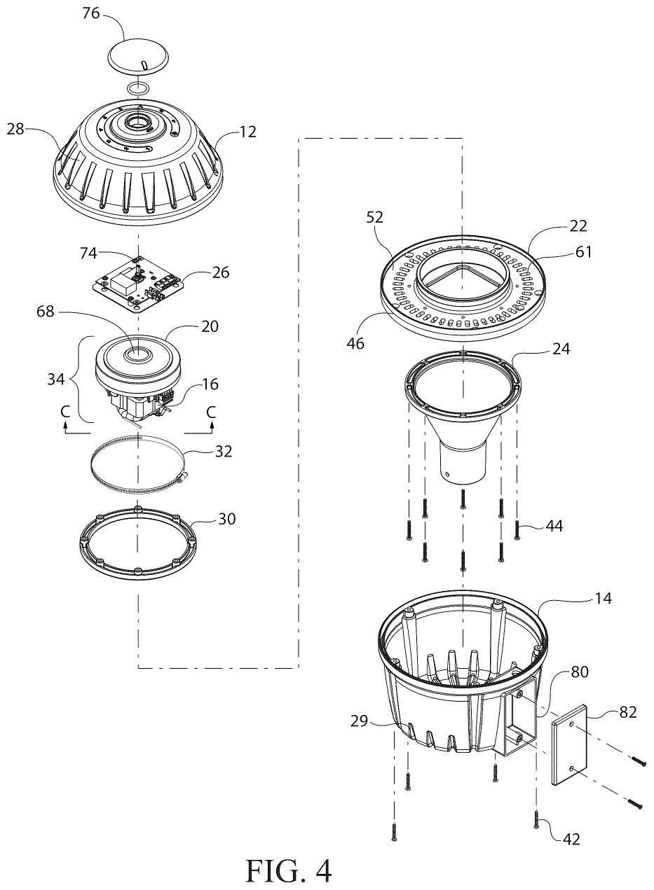

With particular reference to FIGS. 3 and 4, the blower motor 16, fan 18 and fan housing 20 may be configured as a motor-fan assembly 34, i.e. as an assembly where the blower motor 16 and fan 18 share a common rotating shaft and where the fan housing 20 is connected to the blower motor 16. The motor-fan assembly 34 is configured to be attached to the vibration dampener 22. In the exemplary embodiment, a clamping ring 30 and a clamping band 32 are used to removably attach the motor-fan assembly 34 to the vibration dampener 22. (See FIG. 4.)

The vibration dampener 22 will typically be made from an elastomeric material such as rubber. Other elastomeric materials are also suitable. The vibration dampener 22 functions to isolate the blower motor 16 and fan 18 from direct contact with the upper and lower housings 12 and 14 and thereby reduces blower motor and fan noise in the variable speed air blower 10.

The upper housing 12 includes an upper radial slot 48 about its periphery and the lower housing 14 includes a lower radial slot 50 about its periphery. The vibration dampener 22 includes a radial flange 46 about its periphery that interfaces with both the upper radial slot 48 of the upper housing 12 and the lower radial slot 50 of the lower housing 14. In the exemplary embodiment, the vibration dampener 22, with the blower motor 16, fan 18, fan housing 20 and air outlet cone 24 attached, is attached to the upper housing 12 with removable fasteners, such as screws 44.

The upper housing 12 encloses the fan housing 20 and a top portion 52 of the vibration dampener 22 to define an upper air chamber 54. The blower motor speed control unit 26 is attached to the upper housing 12 within the upper air chamber 54 defined by the upper housing 12. In the exemplary embodiment, the upper and lower housings 12 and 14 are attached via removable fasteners such as screws 42.

With particular reference to FIGS. 3 and 4, the air outlet cone 24 surrounds the fan housing air outlet 36 and partially surrounds the blower motor 16. The air outlet cone 24 divides the interior of the lower housing 14 into an inlet air chamber 56 and an outlet air chamber 58 and thereby isolates inlet air 38 from outlet air 40.

With reference to FIGS. 3-4 and 5, the fan 18, when operating, draws inlet air 38 through the air inlets 60 formed in a bottom 62 of the lower housing 14 into the inlet air chamber 56, which is formed by the space between an interior wall 64 of the lower housing 14 and an exterior wall 66 of the air outlet cone 24. The inlet air 38 is pulled through the inlet air chamber 56 by suction created by the fan 18 through the air inlets 61 formed in the vibration dampener 22 and into the upper air chamber 54, where the inlet air 38 cools the blower motor speed control unit 26.

Passing through the upper air chamber 54, the inlet air 38 is drawn into the inlet 68 of the fan housing 20, where the fan 18 compresses the air and expels it at high velocity from the fan housing 20 through a fan housing air outlet 36. Air expelled from the fan housing air outlet 36 is referred to as outlet air 40. Outlet air 40 passes from the fan housing air outlet 36 into the outlet air chamber 58, which is defined by the interior volume of the air outlet cone 24. The outlet air 40 cools the blower motor 16 and is subsequently exhausted though the air outlet 70 of the air outlet cone 24. Isolating the inlet air 38 from the outlet air 40 serves to improve cooling of the blower motor 16, which allows for increased blower motor capacity.

With continued reference to FIGS. 3 and 4, the blower motor speed control unit 26 attaches to an interior surface 72 of the upper housing 12 and is disposed within the upper air chamber 54. The blower motor speed control unit 26 includes a manual speed adjustment control 74, which extends upwardly through an opening in the upper housing 12 to provide for manual control of blower motor speed.

With reference to FIG. 4, an electrical box 80 for electrical wiring having a cover 82 is formed integrally with the lower housing 14. The electrical box 80 may include a single gang junction that allows customers to wire power through standard toggle switches or smart IoT switches.

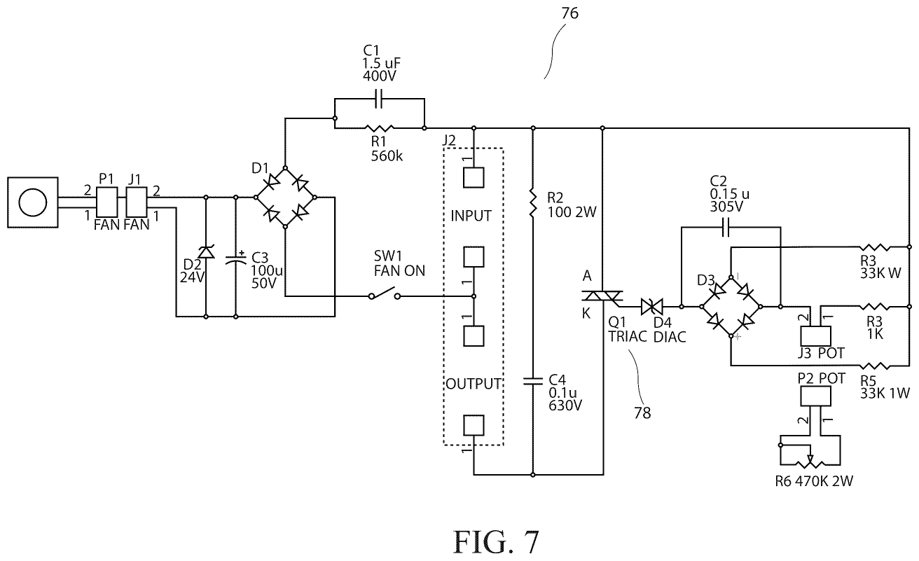

FIG. 7 is a circuit schematic illustrating a control circuit 76 suitable for use in the blower motor speed control unit 26 of the variable speed air blower 10 of the present invention. The control circuit 76 controls motor speed by chopping the AC wave form using a triac 78 based dimmer switch circuit. The control circuit 76 uses a microprocessor to control the dimmer circuit. Microprocessor control provides the ability to monitor the temperature of the motor 16 and thereby reduce motor speed if the temperature exceeds a preset threshold, thus preventing the motor 16 from overheating.

The control circuit 76 is also able to communicate with external automation controls via a two (2) wire RS485 standard for on/off control and speed control. The control circuit 76 is also capable of reporting back device error codes and reporting system health. The control circuit 76 further includes a manual speed adjustment control 74 for manually controlling motor speed. The control circuit 76 also allows the motor 16 be turned on or off utilizing a low voltage, dry contact signal.

The foregoing detailed description and appended drawings are intended as a description of the presently preferred embodiment of the invention and are not intended to represent the only forms in which the present invention may be constructed and/or utilized. Those skilled in the art will understand that modifications and alternative embodiments of the present invention which do not depart from the spirit and scope of the foregoing specification and drawings, and of the claims appended below are possible and practical. It is intended that the claims cover all such modifications and alternative embodiments.

1. A variable speed air blower comprising:
an upper housing and a lower housing, and a motor and fan assembly;
a vibration dampener, wherein the motor and fan assembly are attached to the vibration dampener;
a hollow cone, attached to the vibration dampener;
wherein, the vibration dampener, motor and fan assembly and hollow cone are enclosed within the lower housing and the upper housing;
wherein the interior of the upper housing defines an upper air chamber;
wherein the hollow cone divides the interior of lower housing into an inlet air chamber and an outlet air chamber for the purpose of isolating inlet air flow from outlet air flow;
wherein a motor speed control unit includes a control circuit mounted within the upper air chamber; and
wherein the control circuit is configured to operate the motor at variable speeds.

2. The variable speed air blower of claim 1 wherein the motor and fan assembly are configured on a common rotating shaft.

3. The variable speed air blower of claim 1 wherein the upper housing includes indentations spaced about the perimeter of the upper housing, the indentations serving to increase the surface area of the upper housing.

4. The variable speed air blower of claim 1 wherein the lower housing includes indentations spaced about the perimeter of the lower housing, the indentations serving to increase the surface area of the lower housing.

5. The variable speed air blower of claim 1 wherein the lower housing includes an air inlet opening and an air outlet opening.

6. The variable speed air blower of claim 1 wherein the lower housing includes an box integral with the housing for electrical connections.

7. The variable speed air blower of claim 1 wherein the control circuit includes a micro-processer.

8. The variable speed air blower of claim 1 wherein the control circuit utilizes a triac to control the motor's speed.

9. A variable speed air blower comprising:
an upper housing and a lower housing;
a motor and fan assembly, where the motor and fan are configured on a common rotating shaft;
a vibration dampener, where the motor and fan assembly are attached to the vibration dampener;
wherein, the vibration dampener and motor and fan assembly are enclosed within the lower housing and the upper housing;
wherein the interior of the upper housing defines an upper air chamber;
wherein the interior of the lower housing is configured such that inlet air flow is isolated from outlet air flow in the lower housing; and
a motor speed control unit capable of variably controlling the motor speed.

10. The variable speed air blower of claim 9 wherein the upper housing includes indentations spaced about the perimeter of the upper housing, the indentations serving to increase the surface area of the upper housing.

11. The variable speed air blower of claim 9 wherein the lower housing includes indentations spaced about the perimeter of the upper housing, the indentations serving to increase the surface area of the lower housing.

12. The variable speed air blower of claim 9 wherein the lower housing includes an air inlet opening and an air outlet opening.

13. The variable speed air blower of claim 9 wherein the interior of the lower housing is divided into a inlet air chamber and an outlet air chamber by means of an air cone.

14. The variable speed air blower of claim 9 wherein the air cone is attached to the vibration dampener.

15. The variable speed air blower of claim 9 wherein the motor speed control unit includes a circuit having a micro-processer.

16. The variable speed air blower of claim 9 wherein the circuit utilizes a triac to control the motor's speed.

17. The variable speed air blower of claim 9 wherein the circuit is compatible with an RS485 communications standard.

18. A variable speed air blower comprising:
an upper housing and a lower housing;
a motor and fan assembly, wherein the motor and fan are configured on a common rotating shaft;
wherein, the motor and fan assembly are enclosed within the lower housing and the upper housing; and
a motor speed control unit capable of variably controlling the motor speed.

19. The variable speed air blower of claim 18 wherein the upper housing and lower housing are configured such that inlet airflow is isolated from outlet airflow.

20. The variable speed air blower of claim 18 wherein the motor speed control circuit includes a control circuit.
